(19) United States
(12) Patent Application Publication
(10) Pub. No.: US 2026/0162365 A1
(43) Pub. Date: Jun. 11, 2026

(54) METHOD AND SYSTEM FOR INTEGRATING AND RENDERING 2D AND 3D OBJECTS

(71) Applicant: HUAWEI TECHNOLOGIES CO., LTD., Shenzhen (CN)

(72) Inventors: Shunguang DING, White Rock (CA); Kirtan Shah, Burnaby (CA)

(21) Appl. No.: 18/969,571

(22) Filed: Dec. 5, 2024

(51) Int. Cl. G06T 17/00; G06T 13/40

(52) U.S. Cl. CPC G06T 17/005; G06T 13/40; G06T 2210/21

(57) ABSTRACT

Methods and systems for integrating and rendering two-dimensional (2D) and three-dimensional (3D) objects using a hierarchical tree structure. The tree structure comprises nodes representing 2D or 3D objects, organized by parent-child associations. Interaction conditions are monitored to detect events, such as user input or physical interactions, and corresponding actions, such as state or attribute updates, are performed. Updated states or attributes are provided to a rendering service to generate a composite visual output. These methods and systems enable efficient, dynamic, and seamless interaction and rendering of 2D and 3D graphical elements.

### TECHNICAL FIELD

The present disclosure relates to methods and systems for integrating and rendering two-dimensional (2D) and three-dimensional (3D) objects within graphical applications, in particular, to methods and systems for integrating and rendering 2D and 3D objects using hierarchical tree structures and interaction-based dynamic updates.

### BACKGROUND

The increasing complexity of user interfaces and graphical applications has created a significant demand for systems that can efficiently handle both 2D and 3D objects. In modern applications, 2D objects are often used in user interfaces, simple visual elements, and overlay graphics, while 3D objects provide enhanced visual depth and more interactive and immersive experiences. Each type of graphical object requires specific techniques for representation, rendering, and interaction, often requiring different handling in traditional systems.

Traditional approaches to graphical rendering typically separate the management of 2D and 3D objects, resulting in increased resource consumption, development complexity, and inefficiencies in system performance. For example, these systems often require independent processes for handling 2D and 3D interactions, state changes, and rendering tasks, resulting in higher computational loads. In addition, as applications become more complex, maintaining synchronization between 2D and 3D graphical elements can present additional challenges, including increased power consumption and slower rendering speeds.

As the demand for visually rich and interactive applications continues to grow, the limitations of traditional methods for integrating 2D and 3D graphics have become more apparent. Developers face significant obstacles in creating seamless interactions and achieving satisfying performance when 2D and 3D objects are involved at the same time. These inefficiencies underscore the need for more cohesive approaches to managing and rendering mixed-dimensional graphical elements in modern applications.

### SUMMARY

According to a first aspect, there is provided a method comprising: accessing a pre-configured tree structure comprising a plurality of nodes, each node presenting one of a plurality of two-dimensional (2D) objects or one of a plurality of three-dimensional (3D) objects, the tree structure being based on hierarchical relationships that define parent-child associations among the nodes; monitoring a plurality of interaction conditions associated with the nodes, the interaction conditions including a plurality of events corresponding to a plurality of actions, each event defining at least one of user input or a physical interaction in relation to the 2D and 3D objects, each action defining a display operation on at least one of the 2D and 3D objects; determining whether one of the interaction conditions is satisfied between at least one of the 2D objects and at least one of the 3D objects; in response to determining that one of the interaction conditions is satisfied: updating states or attributes of the nodes associated with the satisfied interaction condition; and providing the updated states or attributes to a rendering service to generate a composite visual output comprising the rendered 2D and 3D objects.

In some embodiments, the method may further comprises: traversing the tree structure to identify a dirty region requiring re-rendering, the dirty region representing a portion of a scene affected by a change in the states or attributes of one or more of the plurality of 2D and 3D objects within the tree structure, and the updating may comprise: updating the states or attributes of the 2D and 3D objects for the dirty region to optimize rendering.

In some embodiments, the physical interaction may be determined using: proximity detection for determining spatial relationships between the 2D and 3D objects; and collision detection for identifying the 2D and 3D objects that are overlapping or intersecting during the interactions.

In some embodiments, the action may comprise one or more of: activating an animation associated with at least one of the 2D and 3D objects; or modifying at least one of the states or attributes of the 2D and 3D objects.

In some embodiments, the method may further comprise: accessing a sub-tree in the tree structure, wherein the sub-tree represents a grouping of 2D objects for off-screen rendering; generating a texture map for the 2D objects within the sub-tree as part of the off-screen rendering; and associating the texture map with corresponding 3D objects for application during the rendering of the composite visual output.

In some embodiments, the 3D objects may be represented as leaf nodes of the tree structure such that the 3D objects are rendered without traversal of additional child nodes.

In some embodiments, the method may further comprise: determining visibility among the 2D and 3D objects based on occlusion relationships defined by their hierarchical arrangement in the tree structure.

In some embodiments, the rendering service may be configured to render the 2D objects using a 2D drawing application programming interface (API) and render the 3D objects using a 3D drawing API, and wherein the composite visual output reflects the updated states or attributes of the 2D and 3D objects.

In some embodiments, the method may further comprise updating the tree structure in response to a change in the states or attributes of the 2D and 3D objects by propagating the change through affected nodes to maintain hierarchical consistency.

In some embodiments, updating the tree structure may comprise: traversing the tree structure to identify affected nodes based on the change in the states or attributes of the 2D and 3D objects; and updating at least one of the parent-child associations, the states, or the attributes of the affected nodes to reflect the change; and propagating the change through the tree structure to maintain hierarchical consistency, including preserving the associations, states, and attributes of unaffected nodes.

According to a second aspect, there is provided a method comprising: generating a tree structure comprising a plurality of nodes, the tree structure being based on hierarchical relationships that define parent-child associations among the nodes; allocating a plurality of two-dimensional (2D) objects and a plurality of three-dimensional (3D) objects to the nodes of the tree structure, so that each node presents one of a plurality of 2D objects or one of a plurality of 3D objects; associating states and attributes with the nodes of the tree structure, the states representing dynamic conditions, the attributes representing static properties, wherein the states and attributes are used to determine rendering parameters for corresponding 2D and 3D objects; and associating a plurality of interaction conditions with the nodes of the tree structure, the interaction conditions including a plurality of events corresponding to a plurality of actions, each event defining at least one of user input or a physical interaction in relation to the 2D and 3D objects, each action defining a display operation on at least one of the 2D and 3D objects.

In some embodiments, the 3D objects may be represented as leaf nodes of the tree structure such that the 3D objects are rendered without traversal of additional child nodes.

In some embodiments, the physical interaction may be determined using: proximity detection for determining spatial relationships between the 2D and 3D objects; and collision detection for identifying the 2D and 3D objects that are overlapping or intersecting during the interactions.

According to a third aspect, there is provided a system comprising: a processing unit; a memory communicatively coupled to the processing unit and storing instructions that, when executed by the processing unit, cause the system to: access a pre-configured tree structure comprising a plurality of nodes, each node presenting one of a plurality of two-dimensional (2D) objects or one of a plurality of three-dimensional (3D) objects, the tree structure being based on hierarchical relationships that define parent-child associations among the nodes; monitor a plurality of interaction conditions associated with the nodes, the interaction conditions including a plurality of events corresponding to a plurality of actions, each event defining at least one of user input or a physical interaction in relation to the 2D and 3D objects, each action defining a display operation on at least one of the 2D and 3D objects; determine whether one of the interaction conditions is satisfied between at least one of the 2D objects and at least one of the 3D objects; in response to determining that one of the interaction conditions is satisfied: update states or attributes of the nodes associated with the satisfied interaction condition; and provide the updated states or attributes to a rendering service to generate a composite visual output comprising the rendered 2D and 3D objects; and a display configured to present the composite visual output.

In some embodiments, the memory may further store instructions that, when executed by the processing unit, cause the system to: traverse the tree structure to identify a dirty region requiring re-rendering, the dirty region representing a portion of a scene affected by a change in the states or attributes of one or more of the plurality of 2D and 3D objects within the tree structure, wherein the states or attributes are updated for the dirty region to optimize rendering.

In some embodiments, the physical interaction may be determined using: proximity detection for determining spatial relationships between the 2D and 3D objects; and collision detection for identifying the 2D and 3D objects that are overlapping or intersecting during the interactions.

In some embodiments, the action may comprise one or more of: activating an animation associated with at least one of the 2D and 3D objects; or modifying at least one of the states or attributes of the 2D and 3D objects.

In some embodiments, the memory may further store instructions that, when executed by the processing unit, cause the system to: access a sub-tree within the tree structure, wherein the sub-tree represents a grouping of 2D objects for off-screen rendering; generate a texture map for the 2D objects within the sub-tree as part of the off-screen rendering; and associate the texture map with corresponding 3D objects for application during the rendering of the composite visual output.

In some embodiments, the 3D objects may be represented as leaf nodes of the tree structure such that the 3D objects are rendered without traversal of additional child nodes.

In some embodiments, the memory may further store instructions that, when executed by the processing unit, cause the system to: determine visibility among the 2D and 3D objects based on occlusion relationships defined by their hierarchical arrangement in the tree structure.

The disclosed methods and systems provide benefits and technical effects by offering a unified framework for managing and rendering 2D and 3D graphical objects. By leveraging a hierarchical tree structure, the methods and systems simplify the integration of 2D and 3D objects, enabling seamless interactions, efficient updates, and cohesive rendering. The dynamic monitoring and updating of states and attributes supports that changes in the graphical scene are reflected in real time, improving responsiveness and interactivity. Additional performance optimizations, such as representing 3D objects as leaf nodes and using off-screen rendering for 2D content, reduce computational overhead, enhance rendering efficiency, and conserve system resources. These advancements make the framework adaptable for applications in diverse environments, including resource-constrained devices, while delivering improved user experiences and streamlined development workflows.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIG. 1 is a tree structure utilized in a fusion framework, according to an example embodiment.

FIG. 2 is a process for constructing or configuring a tree structure, according to an example embodiment.

FIG. 3 is a flowchart of operational steps performed during the execution of a rendering process, according to an example embodiment.

FIG. 4 is a process performed by a fusion manager for dynamically managing interactions and rendering of 2D and 3D objects, according to an example embodiment.

FIG. 5 is a system architecture that enables unified interactions and rendering of 2D and 3D objects, according to an example embodiment.

### DETAILED DESCRIPTION

Existing technologies for creating and managing 2D and 3D objects in interactive applications, such as games, simulations, and user interfaces, provide tools like rendering pipelines, physics engines, and cross-platform support. While some platforms focus on high-fidelity 3D rendering with complex interactions, they are often resource-intensive and unsuitable for lightweight or edge devices.

Other platforms support both 2D and 3D object creation but typically handle them separately, leading to increased development complexity and higher resource consumption when integrating mixed-dimensional elements. Lightweight, open-source solutions cater to lower-end devices by prioritizing efficiency and ease of use but often lack advanced features and robust developer support.

These existing solutions face challenges in managing interactions, state changes, and rendering tasks between 2D and 3D objects within a unified framework. Independent handling of 2D and 3D graphics results in inefficiencies, computational overhead, and a fragmented development process.

The present disclosure includes a “fusion framework”, which facilitates the unified management of 2D and 3D objects. The fusion framework organizes these objects into a tree structure, wherein each object is represented as a node. The nodes are arranged hierarchically based on parent-child relationships, allowing for structured interactions and updates. For instance, a parent node may represent a composite object, while its child nodes may represent individual components. The framework described herein simplifies interaction management, enhances rendering efficiency, and reduces computational overhead for real-time applications.

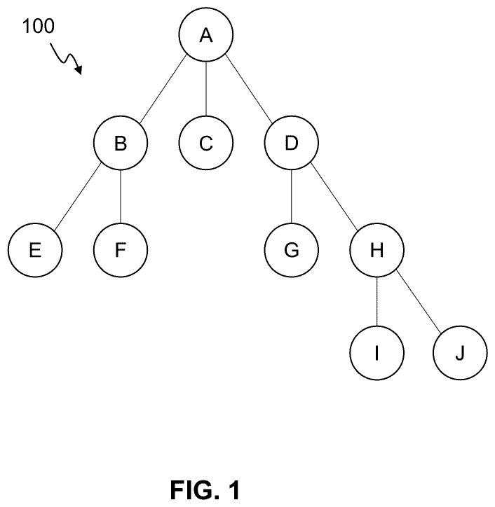

FIG. 1 illustrates an example tree structure 100 utilized in the fusion framework described herein. In the tree structure 100, the root node (labeled as “A”) serves as the top-level node and represents the entire graphical structure or scene. The leaf nodes (e.g., “E”, “F”, “C”, “G”, “I”, and “J”) represent objects without any child nodes, typically corresponding to terminal graphical elements. The intermediate nodes, such as “B”, “D”, and “H” are connected to one or more child nodes. For example, node “B” is a parent node with child nodes “E” and “F”, and node “D” is a parent node with child nodes “G” and “H”. The hierarchical relationships between the parent and child nodes define the organization and dependencies of 2D and 3D objects in the graphical scene.

In the present disclosure, each node in the tree structure is associated with states and attributes. States refer to dynamic conditions, such as visibility or interaction status, which may change in response to user inputs or real-time interactions. Attributes refer to static properties, such as position, scale, or transformation, that define the spatial or visual characteristics of the objects represented by the nodes. The association of states and attributes with nodes enables the tree structure to adapt dynamically to changes in the application environment. For example, if the state of node “B” changes, such as becoming invisible, the change may propagate to its child nodes “E” and “F” to maintain consistency across the hierarchical structure. This organization helps maintain synchronization and interactivity for 2D and 3D objects within the application.

The fusion framework further supports the definition and application of “interaction conditions”. Interaction conditions are predefined rules that trigger specific actions in response to events, such as user inputs (e.g., clicking, dragging) or physical interactions (e.g., proximity or collision among objects). These conditions may be associated with the nodes in the tree structure, facilitating that interactions between 2D and 3D objects are handled cohesively.

Specifically, interaction conditions may include two main components: events and actions. Events define the criteria for triggering a response, such as detecting a user input or identifying a collision between objects. Actions specify the operations to be performed when an event occurs, such as activating an animation, modifying a state or attribute, or altering a visual effect. For instance, when a collision is detected between a 2D object and a 3D object, the system may trigger an action to modify the visual properties of both objects.

A rendering process in the present disclosure integrates the 2D and 3D objects within the tree structure to generate a composite visual output. Rendering is performed using 2D and 3D drawing application programming interfaces (APIs), which process the current states and attributes of the objects. By combining the outputs of these APIs, the system supports that the composite visual output reflects all interactions and updates.

Off-screen rendering may be employed during the runtime of the application to improve the rendering process for 2D objects. In this approach, groups of 2D objects may be dynamically rendered into texture maps when required, based on the current state of the application or user interactions. These texture maps are then applied to corresponding 3D objects for seamless integration. For example, if a user interaction requires displaying a 2D user interface element on a 3D surface, the system renders the 2D element off-screen into a texture map at that moment and maps it onto the 3D surface. This approach reduces the computational load during real-time rendering and allows efficient and cohesive visual output.

To further enhance efficiency, the rendering process may utilize dirty region optimization, which limits updates to only the portions of the scene affected by changes. This approach minimizes unnecessary computations, conserving resources and improving performance. For instance, when a state change affects only a small subset of nodes in the tree structure, rendering operations are restricted to the corresponding dirty region.

The disclosure includes a “fusion manager”, a dedicated module (which may be implemented as an API) responsible for evaluating interaction conditions, triggering state updates, and coordinating rendering operations. The fusion manager is configured to manage the tree structure generated during the application's initialization. This tree structure may incorporate the 2D and 3D objects, their associated states, attributes, and interaction conditions, as defined by the developer during the initialization. The fusion manager can then continuously monitor real-time interactions during runtime and dynamically responds to changes. For example, when a user input satisfies an interaction condition, the fusion manager accesses the tree structure to identify and update the relevant nodes and triggers the corresponding rendering actions to reflect the updated states or attributes.

In addition to real-time monitoring and updates, the fusion manager may propagate state changes through the tree structure to maintain hierarchical consistency. When a parent node's state or attribute is updated (e.g., visibility changes), this update may propagate to relevant child nodes and associated attributes to maintain coherence across the tree structure.

The present disclosure may additionally address performance challenges through the hierarchical generation and organization of the tree structure and the use of optimization techniques. For example, 3D objects may be represented as leaf nodes in the tree structure, meaning they do not contain additional child nodes. This design may reduce traversal overhead during rendering. By associating 3D objects with low-level rendering operations in the rendering service, the system can reduce computational complexity and enhance performance, particularly for applications with complex 3D geometries and rendering requirements.

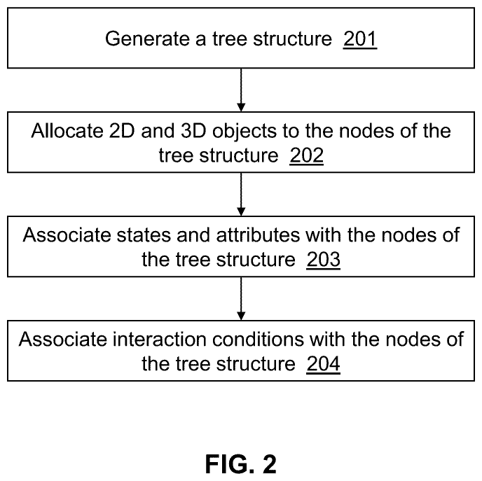

FIG. 2 illustrates an example process for constructing or configuring a tree structure for managing and rendering 2D and 3D objects within a graphical application. The tree structure is designed to facilitate seamless interactions and rendering by organizing 2D and 3D objects hierarchically and associating relevant data for real-time operations.

At operation 201, a tree structure is generated based on hierarchical relationships. Each node of the tree structure represents either a 2D object or a 3D object. The hierarchical relationships define parent-child associations, wherein a parent node can encapsulate or influence its child nodes. For example, a parent node may represent a composite graphical element, such as a menu or a container, while its child nodes represent the individual components, such as buttons or icons.

At operation 202, a plurality of 2D and 3D objects are allocated to the nodes of the tree structure. Each node is assigned a specific object, so that every 2D and 3D object within the application can be represented. For instance, a 2D object such as a button may be allocated to a node in a section of the tree representing the user interface, while a 3D object such as a model may be allocated to a node in a section representing the graphical scene. This allocation step ensures that the tree structure comprehensively organizes graphical objects of interest within the application.

At operation 203, states and attributes are associated with the nodes of the tree structure. States represent dynamic conditions, such as visibility, interaction status, or animation progress, while attributes represent static properties, such as position, scale, or transformation. These states and attributes are used for determining rendering parameters and for dynamically updating the visual output based on user interactions or other runtime conditions. For example, the visibility state of a node may determine whether the corresponding object is rendered, while the position attribute may define where the object appears on the screen.

At operation 204, interaction conditions are associated with the nodes of the tree structure. Interaction conditions include a plurality of events corresponding to a plurality of actions. Each event defines a trigger, such as user input (e.g., mouse clicks, gestures) or physical interaction (e.g., proximity or collisions among the objects), that activates one or more actions. Each action defines a display operation on at least one of the 2D and 3D objects, such as modifying an object's appearance, triggering animations, or updating states and attributes. For example, a collision event between a 2D icon and a 3D model (such as a ball rolling on the icon in a graphical user interface) may trigger an action to change the icon's shadow depth or to initiate an animation of the 3D model.

The method illustrated in FIG. 2 provides a structured approach to managing 2D and 3D objects within a graphical application for efficient rendering and interaction handling. Developers, such as game developers or mobile operating system (OS) user interface (UI) developers, can use this approach during the development phase to define the tree structure and configure the associated data to meet the specific requirements of the application.

By generating a tree structure and allocating nodes for various objects, such as characters, environmental elements, UI components, or system icons, developers can assign states and attributes to represent dynamic conditions and static properties. Interaction conditions, including events such as user input or physical interactions, can be defined to trigger specific actions like animations, visual effects, or transformations. This enables the application to respond dynamically and contextually during runtime. For example, proximity detection and collision detection can handle physical interactions, while rendering optimizations, such as treating 3D objects as leaf nodes, avoid unnecessary traversal and reduce computational overhead.

This method allows developers to anticipate how objects behave under various conditions, optimizing application performance and interactivity. The hierarchical configuration of the tree structure, combined with the association of states, attributes, and interaction conditions, enhances the graphical rendering process and ensuring a responsive and consistent user experience.

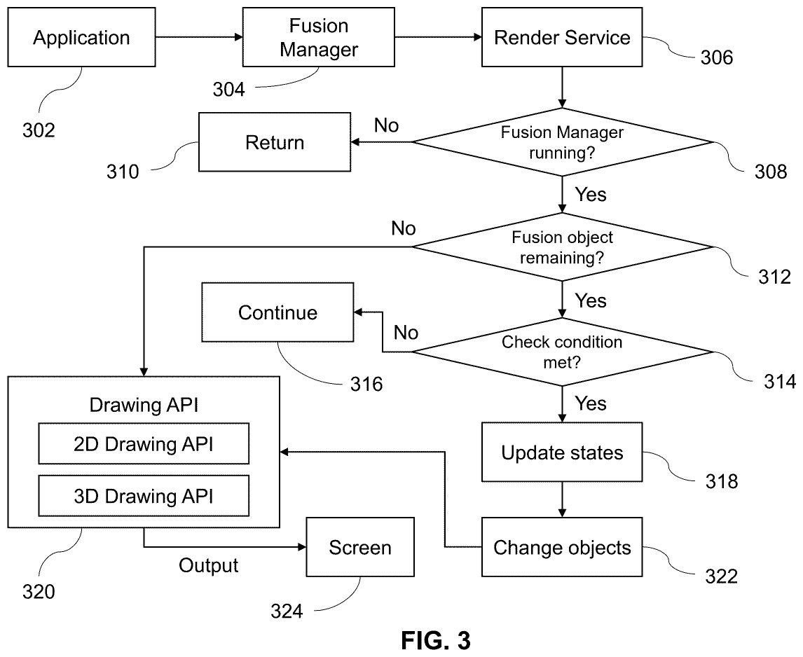

FIG. 3 illustrates an example flowchart depicting the operational steps performed during the execution of a rendering process facilitated by a fusion manager 304. The process starts with an application 302 that initializes the fusion manager, which acts as the core module responsible for managing, monitoring, and processing interactions between 2D and 3D objects. This interaction is governed by the tree structure generated during the tree structure configuration phase as described in respect of FIG. 2. The tree structure organizes 2D and 3D objects hierarchically, with nodes representing objects and defining their parent-child relationships.

Once the fusion manager is initially configured, it communicates with a render service 306. The render service 306 iterates through the fusion objects configured in the fusion manager. Fusion objects are structured entities used to manage the interaction logic and collision detection between 2D and 3D objects. Each fusion object defines specific conditions under which interactions occur, along with the corresponding actions to be executed when those conditions are satisfied. A fusion object includes the necessary conditions, such as user input or physical interactions like collisions or proximity, and specifies the resulting state or attribute changes. These pairs of conditions and actions effectively represent predefined rules, encapsulating both the initiator and recipient of the interaction and the situational context in which it takes place. This structured approach ensures predictable and consistent behavior during runtime by enabling the system to monitor interactions and execute actions dynamically.

For example, a fusion object may specify that when a collision occurs between a 3D object (the initiator) and a 2D object (the recipient), the system triggers an enlarging animation (a state change) for the 3D object or changes its color (an attribute). In another scenario, a fusion object may define that upon receiving a specific user input, the visibility (a state) of an object is toggled, or its position (an attribute) is updated. Actions, which are defined as part of the fusion object, represent the operations the system executes upon satisfying the conditions, such as initiating animations, altering object states, or applying visual effects. By encapsulating the conditions and actions, the system can facilitate seamless integration and interaction between 2D and 3D objects. Moreover, this approach enables developers to predefine object behaviors during the configuration phase, allowing the render service 306 to efficiently process real-time updates during runtime. This flexibility and predefined structure simplify the fusion of 2D and 3D interactions while maintaining computational efficiency.

At decision block 308, the system checks whether the fusion manager is actively running. The fusion manager may remain operational for the entire process such that all interaction conditions can be continuously monitored. If the fusion manager is not running, the process terminates at return operation 310, meaning that the process is returned to the application 302. This decision point can avoid unnecessary processing when the fusion manager is not active.

If the fusion manager is running, the process advances to decision block 312, where it determines whether there are any remaining fusion objects to process. If there are fusion objects remain, the process proceeds to decision block 314 to evaluate whether the interaction conditions for the current fusion objects are satisfied. Interaction conditions can be evaluated using specialized APIs, such as collision detection or ray casting, to determine whether the required criteria are met.

If an interaction condition is satisfied, the process transitions to block 318, where the fusion manager updates the states or attributes of the affected 2D and 3D objects. The hierarchical relationships defined in the tree structure enable efficient propagation of these updates to maintain consistency across parent and child nodes. For example, if a fusion object specifies that a collision between a 2D icon and a 3D model triggers a visual effect, such as a shadow depth change, the fusion manager updates the corresponding nodes to reflect this change. The updated states or attributes are prepared for rendering by the render service. On the other hand, if the interaction condition is not satisfied, the process continues to check a next interaction condition at 316, until all the interaction conditions have been checked.

Following the state updates at 318, the process moves to block 322, where the fusion manager coordinates changes to the associated 2D and 3D objects. This coordination supports that objects are modified in accordance with the updated states or attributes, preparing them for the rendering. The modifications may include adjustments to positions, animations, or other visual properties.

If there are no fusion objects as determined at 312 or if the objects are changed at 322, the render service then invokes the appropriate 2D and 3D drawing APIs 320 to render the existing objects (as from block 312) or the changed objects (as from block 322). These APIs may be integral to the system, as they handle the actual rendering process for 2D and 3D objects. For example, the 2D drawing API processes objects like user interface elements, while the 3D drawing API handles complex models requiring depth and perspective rendering. By using these APIs, the render service generates a composite visual output that seamlessly integrates 2D and 3D elements.

Finally, the rendered output is displayed on the screen at block 324. This step supports that all updates, including state or attribute changes and interactions, are visually reflected in real-time. The seamless integration of 2D and 3D objects into a unified composite output enhances the end-user experience by maintaining synchronization and interactivity. This output may be dynamic to reflect the continuous monitoring and processing performed by the fusion manager.

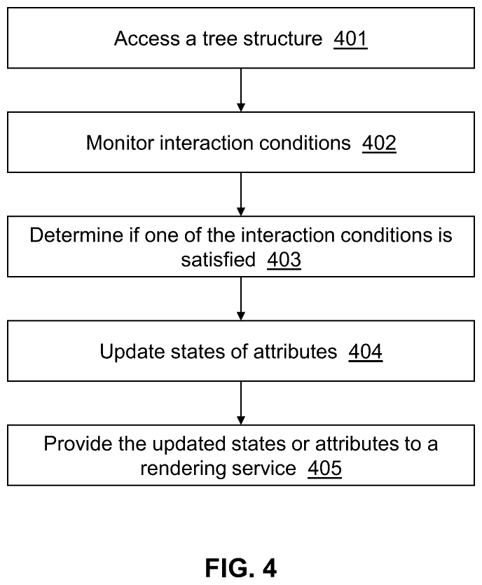

FIG. 4 illustrates a process for dynamically managing the interactions and rendering of 2D and 3D objects within a graphical application. The process may be performed by the fusion manager, as described in respect of FIG. 3, which may be implemented as software, firmware, a dedicated hardware module such as an application-specific integrated circuit (ASIC), or a combination thereof, configured to access, utilize, or modify a pre-configured tree structure to orchestrate interaction monitoring, state updates, and to direct rendering operations.

At operation 401, the fusion manager accesses a pre-configured tree structure comprising a plurality of nodes. Each node represents either a 2D object or a 3D object, and the tree structure is configured based on hierarchical relationships defining parent-child associations, as described in respect of FIG. 2. These relationships provide a logical structure that allows the fusion manager to efficiently traverse the tree and maintain the connections between related objects.

Once the tree structure is accessed, the fusion manager begins monitoring a set of interaction conditions associated with the nodes at operation 402. These interaction conditions include events, and each event is linked to one or more actions that define display operations on the 2D or 3D objects.

At operation 403, the fusion manager evaluates whether any interaction conditions are satisfied by analyzing real-time data from the application. If a condition is met, such as detecting a collision between objects or identifying proximity within a specified threshold, the fusion manager identifies the associated actions and determines the updates required for the relevant objects.

In response to a satisfied condition, the fusion manager updates the states or attributes of the nodes affected by the interaction at operation 404. For example, the fusion manager may update a state to mark an object as visible or adjust attributes to reposition an object within the scene.

Once the updates to states or attributes are completed, the fusion manager provides the updated data to a rendering service at operation 405. The rendering service, configured to render 2D objects using a 2D drawing API and 3D objects using a 3D drawing API, generates a composite visual output.

Optionally, the fusion manager may incorporate additional capabilities to further enhance performance. For example, when only a portion of the scene is affected by updates, the fusion manager may traverse the tree structure to identify dirty regions —specific areas requiring re-rendering. By updating only the affected regions, the fusion manager optimizes computational resources. Additionally, the fusion manager may support off-screen rendering by accessing sub-trees representing groups of 2D objects, generating texture maps, and associating these maps with corresponding 3D objects for efficient integration into the final composite visual output. Furthermore, the fusion manager may evaluate visibility among objects based on their occlusion relationships to facilitate accurate rendering order and visual correctness.

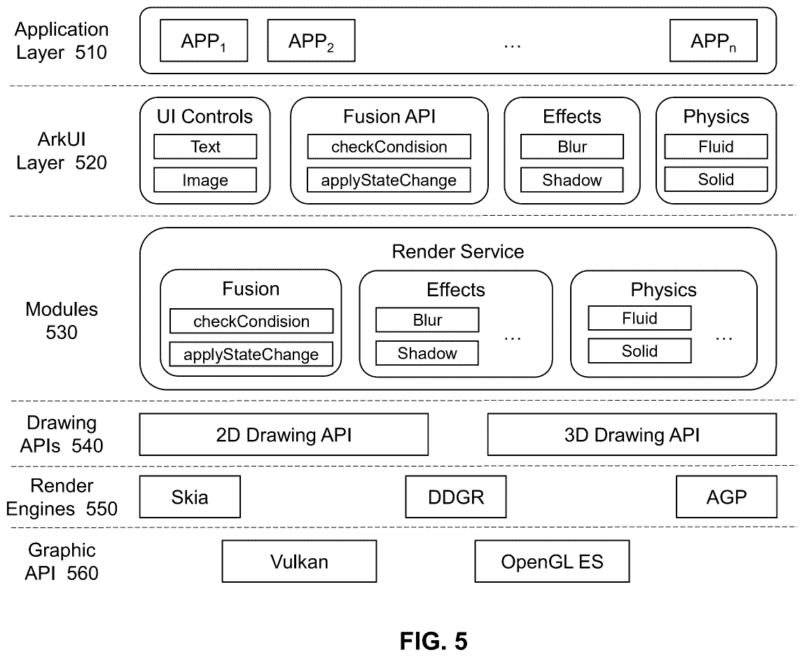

FIG. 5 illustrates a system architecture that enables unified interactions and rendering of 2D and 3D objects in a graphical application, implemented using a fusion API (namely, the fusion manager in respect of FIG. 3). The system comprises multiple layers 510-560, each responsible for distinct tasks, supporting cohesive integration of 2D and 3D components while maintaining efficient rendering and dynamic interaction handling.

At the top of the architecture is an application layer 510, which includes various applications (e.g., APP₁, APP₂, . . . , APPₙ) that require unified 2D and 3D interactions. Developers may configure these applications to specify the required interactions and behaviors between 2D and 3D objects using the fusion API. This layer defines application-specific conditions, state/attribute changes, and rendering requirements.

Beneath the application layer 510 lies an ArkUI Layer 520, which provides a set of UI controls, including text and image components, for example, along with the Fusion API. The Fusion API comprises features such as checkCondition and applyStateChange, which monitor and manage the conditions and state changes of 2D and 3D objects as specified by the application layer. The ArkUI layer 520 may also include additional modules for effects (e.g., blur and shadow) and physics-based interactions (e.g., fluid, solid, or cloth simulations).

Below the ArkUI layer 520, a modules layer 530 houses the render service, which integrates multiple modules, including fusion, effects, and physics. The fusion module, equipped with the same checkCondition and applyStateChange features as the Fusion API, processes the interaction logic provided by the application layer. On each synchronization, the fusion module evaluates whether predefined conditions are satisfied and applies the corresponding state/attribute changes, so that 2D and 3D objects can be updated dynamically and in real time. The effects and physics modules enable additional rendering and interaction functionalities, such as applying visual effects (such as effects of material, blur, particles, environment, lighting, etc.) or simulating physical behaviors (such as behaviros of cloth, fluid, collision, particle, soft body, rigid body, joint constraint, etc.).

A drawing API layer 540 provides dedicated APIs for rendering 2D and 3D components. The 2D Drawing API handles 2D graphical elements, while the 3D Drawing API processes 3D objects. These APIs serve as interfaces between the render service and the underlying rendering engines. A render engines layer 550 (e.g., Skia, Data Driven Graphics Rendering (DDGR), and Accelerated Graphics Port (AGP)) works closely with the drawing APIs to issue specific rendering commands for both 2D and 3D objects. A graphics API layer 560 (e.g., Vulkan© and OpenGL® ES) provides low-level graphical operations, enabling hardware-accelerated rendering. This layer acts as the foundation for all rendering tasks.

The described architecture enables the fusion API to function as a bridge between the application layer and the underlying rendering services. By monitoring conditions and updating states or attributes, the 2D and 3D objects may be rendered cohesively within a unified graphical environment.

The present disclosure also contemplates the flexibility of enabling or disabling the unified rendering of 2D and 3D objects through the use of an API. This capability allows developers to adapt the rendering process based on application requirements or specific runtime scenarios. For instance, in resource-constrained environments, developers may choose to disable certain features of unified rendering to prioritize performance or reduce power consumption. Conversely, in high-fidelity applications, enabling the unified rendering supports seamless interactions between 2D and 3D objects, enhancing the overall user experience.

In one embodiment, the fusion API may facilitate the transmission of critical data required for unified rendering and interactions. This data includes, but is not limited to, transform parameters (e.g., position, scale), dimensions (e.g., width and height), and other attributes essential for synchronization.

The described system may further support real-time interactions of 2D and 3D objects in the same screen space, even when these objects belong to different applications. For example, a 2D user interface element from a messaging application may interact with a 3D object rendered by a separate augmented reality (AR) application. This can be achieved by leveraging the hierarchical tree structure and the fusion manager, which coordinate interactions and state/attribute changes across applications. Such interoperability expands the potential use cases of the fusion API, enabling multi-application environments that provide seamless user experiences.

Another embodiment of the disclosure focuses on creating computer-aided simulation software that utilizes the described framework for managing 2D and 3D object interactions. Such software can simulate complex scenarios where 2D elements, such as charts or annotations, interact with 3D models in real time. For instance, in a simulation of mechanical systems, a 2D overlay may display system parameters while the 3D model responds dynamically to user input or predefined conditions. This capability enhances the simulation's utility, making it suitable for applications such as training, education, and design prototyping.

The fusion API may further improve rendering efficiency by unifying interactions and state/attribute changes for 2D and 3D objects. In one embodiment, a game environment benefits from this unified approach by reducing computational overhead while maintaining high-quality visual outputs. By centralizing the interaction logic within the fusion manager, the system minimizes redundant calculations and accelerates rendering processes.

Additionally, the disclosed framework may be suitable for applications in AR and virtual reality (VR). In these environments, the fusion API enables seamless integration of 2D and 3D elements, such as combining a 2D user interface with immersive 3D content. This integration reduces the performance cost typically associated with rendering complex AR and VR applications, thereby improving user experience while maintaining optimal system performance.

The following is a C++ pseudocode example illustrating the design and implementation of a unified tree structure for managing and rendering 2D and 3D graphical objects, as described in the present disclosure. This pseudocode demonstrates main aspects described herein, including the hierarchical organization of nodes, offscreen rendering of 2D content for integration into 3D scenes, and the use of “fusion objects” to handle interaction logic between 2D and 3D objects. While the example simplifies certain details for clarity, it captures the main functionality and design principles of the described system.

```
#include <iostream>
#include <string>
#include <vector>
// Base Node class representing nodes in the tree structure
class Node {
public:
  std::string name;
  Node* parent;
  std::vector<Node*> children;
  Node(const std::string& n) : name(n), parent(nullptr) { }
  void addChild(Node* child) {
    child->parent = this;
    children.push_back(child);
  }
  virtual void update( ) {
    // Traverse and update all child nodes
    for (Node* child : children) {
      child->update( );
    }
  }
  virtual void render( ) {
    // Traverse and render all child nodes
    for (Node* child : children) {
      child->render( );
    }
  }
  virtual bool isLeaf( ) const {
    return children.empty( );
  }
};
// 2D Object Node
class Object2DNode : public Node {
public:
  Object2DNode(const std::string& n) : Node(n) { }
  void update( ) override {
    std::cout << “Updating 2D Node: ” << name << std::endl;
    Node::update( );
  }
  void render( ) override {
    std::cout << “Rendering 2D Node: ” << name << std::endl;
    Node::render( );
  }
};
// 3D Object Node
class Object3DNode : public Node {
public:
  Object3DNode(const std::string& n) : Node(n) { }
  void update( ) override {
    std::cout << “Updating 3D Node: ” << name << std::endl;
    Node::update( );
  }
  void render( ) override {
    std::cout << “Rendering 3D Node: ” << name << std::endl;
    Node::render( );
  }
  bool isLeaf( ) const override {
    // 3D objects are treated as leaf nodes during rendering
    return true;
  }
};
// Offscreen 2D Rendering Node Tree for generating textures for 3D objects
class Offscreen2DTree : public Node {
public:
  Offscreen2DTree(const std::string& n) : Node(n) { }
  void update( ) override {
    std::cout << “Updating offscreen 2D tree: ” << name << std::endl;
    Node::update( );
  }
  void render( ) override {
    std::cout << “Rendering offscreen 2D tree to texture: ” << name << std::endl;
    // Offscreen rendering logic to generate 2D texture for 3D scenes
  }
};
// Condition class defining interaction logic
class Condition {
public:
  Node* initiator;
  Node* receiver;
  Condition(Node* initiator, Node* receiver)
    : initiator(initiator), receiver(receiver) { }
  bool isSatisfied( ) const {
    // Check interaction conditions, such as collisions
    std::cout << “Checking collision between ” << initiator->name
        << “ and ” << receiver->name << std::endl;
    return false; // Stubbed logic; replace with actual collision detection
  }
};
// Action class defining operations triggered when conditions are satisfied
class Action {
public:
  virtual void execute( ) = 0;
};
class PlayAnimationAction : public Action {
private:
  std::string animationName;
public:
  PlayAnimationAction(const std::string& name) : animationName(name) { }
  void execute( ) override {
    std::cout << “Playing animation: ” << animation Name << std::endl;
  }
};
// FusionObject combining a Condition and an Action
class FusionObject {
public:
  Condition* condition;
  Action* action;
  FusionObject(Condition* cond, Action* act) : condition(cond), action(act) { }
  void update( ) {
    if (condition->isSatisfied( )) {
      action->execute( );
    }
  }
};
// Main program
int main( ) {
  // Create root node (scene tree root)
  Node* root = new Node(“SceneRoot”);
  // Create 2D and 3D nodes and add them to the scene tree
  Object2DNode* uiNode = new Object2DNode(“UINode”);
  Object3DNode* playerNode = new Object3DNode(“PlayerNode”);
  root->addChild(uiNode);
  root->addChild(playerNode);
  // Create an offscreen 2D rendering node tree for embedded 3D content
  Offscreen2DTree* offscreen2D = new Offscreen2DTree(“OffscreenUI”);
  playerNode->addChild(offscreen2D);
  // Define interaction conditions and actions
  Condition* collisionCondition = new Condition(uiNode, playerNode);
  Action* playAnimation = new PlayAnimationAction(“ExplosionAnimation”);
  // Create FusionObject to handle interaction
  FusionObject* fusion = new FusionObject(collisionCondition, playAnimation);
  // Update scene tree and FusionObject
  root->update( );
  fusion->update( );
  // Render the scene
  root->render( );
  // Cleanup memory
  delete root;
  delete fusion;
  return 0;
}
```

The provided code demonstrates a hierarchical tree structure for organizing and managing 2D and 3D graphical objects in the context of the present disclosure. The core of the structure is the Node class, which establishes parent-child relationships among nodes and supports recursive updates and rendering. Specialized subclasses, Object2DNode and Object3DNode, extend the Node class to represent 2D and 3D objects, respectively. During rendering, 3D objects are treated as leaf nodes to optimize traversal and rendering by reducing computational overhead.

The code also incorporates offscreen rendering for integrating 2D content into 3D scenes. This functionality is implemented using the Offscreen2DTree class, which represents a sub-tree for rendering 2D elements into textures. These textures are applied to 3D surfaces, such as mapping a user interface element onto a 3D object, ensuring efficient and cohesive integration of 2D and 3D elements.

To handle interactions, the FusionObject class combines a Condition and an Action. The Condition defines interaction triggers, such as collisions or proximity, while the Action specifies operations to execute when the condition is met, such as triggering animations or modifying object attributes. This pairing enables the system to dynamically manage interactions between 2D and 3D objects.

The update process demonstrated in the code recursively traverses the scene tree to synchronize the states of 2D and 3D objects, ensuring consistency across the hierarchy. The rendering process also leverages the hierarchical structure to render all nodes, allowing for seamless integration of 2D and 3D objects within a unified scene.

The provided example aligns with the present disclosure by demonstrating the integration of a hierarchical tree structure, offscreen rendering, and interaction logic. The design facilitates dynamic and efficient management of 2D and 3D graphical objects for consistent behavior and improved performance during runtime.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A method comprising:
accessing a pre-configured tree structure comprising a plurality of nodes, each node presenting one of a plurality of two-dimensional (2D) objects or one of a plurality of three-dimensional (3D) objects, the tree structure being based on hierarchical relationships that define parent-child associations among the nodes;
monitoring a plurality of interaction conditions associated with the nodes, the interation conditions including a plurality of events corresponding to a plurality of actions, each event defining at least one of user input or a physical interaction in relation to the 2D and 3D objects, each action defining a display operation on at least one of the 2D and 3D objects;
determining whether one of the interaction conditions is satisfied between at least one of the 2D objects and at least one of the 3D objects;
in response to determining that one of the interaction conditions is satisfied:
updating states or attributes of the nodes associated with the satisfied interaction condition; and
providing the updated states or attributes to a rendering service to generate a composite visual output comprising the rendered 2D and 3D objects.

2. The method of claim 1, further comprising:
traversing the tree structure to identify a dirty region requiring re-rendering, the dirty region representing a portion of a scene affected by a change in the states or attributes of one or more of the plurality of 2D and 3D objects within the tree structure, and wherein the updating comprises:
updating the states or attributes of the 2D and 3D objects for the dirty region to optimize rendering.

3. The method of claim 1, wherein the physical interaction is determined using:
proximity detection for determining spatial relationships between the 2D and 3D objects; and
collision detection for identifying the 2D and 3D objects that are overlapping or intersecting during the interactions.

4. The method of claim 1, wherein the action comprises one or more of:
activating an animation associated with at least one of the 2D and 3D objects; or
modifying at least one of the states or attributes of the 2D and 3D objects.

5. The method of claim 1, further comprising:
accessing a sub-tree in the tree structure, wherein the sub-tree represents a grouping of 2D objects for off-screen rendering;
generating a texture map for the 2D objects within the sub-tree as part of the off-screen rendering; and
associating the texture map with corresponding 3D objects for application during the rendering of the composite visual output.

6. The method of claim 1, wherein the 3D objects are represented as leaf nodes of the tree structure such that the 3D objects are rendered without traversal of additional child nodes.

7. The method of claim 1, further comprising:
determining visibility among the 2D and 3D objects based on occlusion relationships defined by their hierarchical arrangement in the tree structure.

8. The method of claim 1, wherein the rendering service is configured to render the 2D objects using a 2D drawing application programming interface (API) and render the 3D objects using a 3D drawing API, and wherein the composite visual output reflects the updated states or attributes of the 2D and 3D objects.

9. The method of claim 1, further comprising updating the tree structure in response to a change in the states or attributes of the 2D and 3D objects by propagating the change through affected nodes to maintain hierarchical consistency.

10. The method of claim 9, wherein updating the tree structure comprises:
traversing the tree structure to identify affected nodes based on the change in the states or attributes of the 2D and 3D objects; and
updating at least one of the parent-child associations, the states, or the attributes of the affected nodes to reflect the change; and
propagating the change through the tree structure to maintain hierarchical consistency, including preserving the associations, states, and attributes of unaffected nodes.

11. A method comprising:
generating a tree structure comprising a plurality of nodes, the tree structure being based on hierarchical relationships that define parent-child associations among the nodes;
allocating a plurality of two-dimensional (2D) objects and a plurality of three-dimensional (3D) objects to the nodes of the tree structure, so that each node presents one of a plurality of 2D objects or one of a plurality of 3D objects;
associating states and attributes with the nodes of the tree structure, the states representing dynamic conditions, the attributes representing static properties, wherein the states and attributes are used to determine rendering parameters for corresponding 2D and 3D objects; and
associating a plurality of interaction conditions with the nodes of the tree structure, the interaction conditions including a plurality of events corresponding to a plurality of actions, each event defining at least one of user input or a physical interaction in relation to the 2D and 3D objects, each action defining a display operation on at least one of the 2D and 3D objects.

12. The method of claim 11, wherein the 3D objects are represented as leaf nodes of the tree structure such that the 3D objects are rendered without traversal of additional child nodes.

13. The method of claim 11, wherein the physical interaction is determined using:
proximity detection for determining spatial relationships between the 2D and 3D objects; and
collision detection for identifying the 2D and 3D objects that are overlapping or intersecting during the interactions.

14. A system comprising:
a processing unit;
a memory communicatively coupled to the processing unit and storing instructions that, when executed by the processing unit, cause the system to:
access a pre-configured tree structure comprising a plurality of nodes, each node presenting one of a plurality of two-dimensional (2D) objects or one of a plurality of three-dimensional (3D) objects, the tree structure being based on hierarchical relationships that define parent-child associations among the nodes;
monitor a plurality of interaction conditions associated with the nodes, the interaction conditions including a plurality of events corresponding to a plurality of actions, each event defining at least one of user input or a physical interaction in relation to the 2D and 3D objects, each action defining a display operation on at least one of the 2D and 3D objects;
determine whether one of the interaction conditions is satisfied between at least one of the 2D objects and at least one of the 3D objects;
in response to determining that one of the interaction conditions is satisfied:
update states or attributes of the nodes associated with the satisfied interaction condition; and
provide the updated states or attributes to a rendering service to generate a composite visual output comprising the rendered 2D and 3D objects; and
a display configured to present the composite visual output.

15. The system of claim 14, wherein the memory further stores instructions that, when executed by the processing unit, cause the system to:
traverse the tree structure to identify a dirty region requiring re-rendering, the dirty region representing a portion of a scene affected by a change in the states or attributes of one or more of the plurality of 2D and 3D objects within the tree structure, wherein the states or attributes are updated for the dirty region to optimize rendering.

16. The system of claim 14, wherein the physical interaction is determined using:
proximity detection for determining spatial relationships between the 2D and 3D objects; and
collision detection for identifying the 2D and 3D objects that are overlapping or intersecting during the interactions.

17. The system of claim 14, wherein the action comprises one or more of:
activating an animation associated with at least one of the 2D and 3D objects; or
modifying at least one of the states or attributes of the 2D and 3D objects.

18. The system of claim 14, wherein the memory further stores instructions that, when executed by the processing unit, cause the system to:
access a sub-tree within the tree structure, wherein the sub-tree represents a grouping of 2D objects for off-screen rendering;
generate a texture map for the 2D objects within the sub-tree as part of the off-screen rendering; and
associate the texture map with corresponding 3D objects for application during the rendering of the composite visual output.

19. The system of claim 14, wherein the 3D objects are represented as leaf nodes of the tree structure such that the 3D objects are rendered without traversal of additional child nodes.

20. The system of claim 14, wherein the memory further stores instructions that, when executed by the processing unit, cause the system to:
determine visibility among the 2D and 3D objects based on occlusion relationships defined by their hierarchical arrangement in the tree structure.
